(19) United States
(12) Patent Application Publication
(10) Pub. No.: US 2026/0206112 A1
(43) Pub. Date: Jul. 16, 2026

(54) CONTROL METHOD AND APPARATUS FOR LIGHT SOURCES

(71) Applicant: LUMILEDS LLC, San Jose, CA (US)

(72) Inventors: Wouter Anthon SOER, Utrecht (NL); Johannes Willem Herman Sillevis-Smitt, San Jose, CA (US); Rob Jacques Paul Engelen, Eindhoven (NL); Mehdi Aas, Eindhoven (NL)

(73) Assignee: LUMILEDS LLC, San Jose, CA (US)

(21) Appl. No.: 19/136,399

(22) PCT Filed: Dec. 18, 2023
(86) PCT No.: PCT/US2023/084612

§ 371 Date: Jun. 6, 2025

Related U.S. Application Data
(60) Provisional application No. 63/433,117, filed on Dec. 16, 2022.

(51) Int. Cl. H05B 47/11; G01J 1/02; G01J 1/42; H05B 45/12; H05B 47/175; H05B 47/19

(52) U.S. Cl. CPC H05B 47/11; G01J 1/0233; G01J 1/42; H05B 45/12; H05B 47/19; H05B 47/1985; H05B 47/199; G01J 2001/4252

(57) ABSTRACT

A method for controlling light sources of a lighting system includes initializing a measurement device for measuring information in the lighting system. Photometric data is recorded at a first location, and the measurement records photometric data at a second location. Target illuminance in the system is set at the first and second locations, and flux values for lighting elements of the lighting system are calculated. Control parameters are transmitted based upon the flux for adjustment of the elements in the lighting system.

### CROSS REFERENCE TO RELATED APPLICATIONS

This application claims the benefit of U.S. Provisional Patent Application No. 63/433,117, which was filed on Dec. 16, 2022, the contents of which are hereby incorporated by reference herein as if fully set forth.

### BACKGROUND

Addressable LED arrays consisting of segmented LEDs or discrete mini-LEDs are attractive for creating digital light sources with variable spatial light emission. When combined with directional projection optics, the addressability of the array elements enables beam shaping or steering functionality.

### SUMMARY

A method for controlling light sources of a lighting system includes initializing a measurement device for measuring information in the lighting system. Photometric data is recorded at a first location and photometric data is recorded at a second location. Target illuminance in the system is set at the first and second locations, and flux values for lighting elements of the lighting system are calculated. Control parameters are transmitted based upon the flux for adjustment of the elements in the lighting system.

### BRIEF DESCRIPTION OF THE DRAWINGS

FIG. 1A is a top view illustration of an LED array with an exploded portion;

FIG. 1B is a cross sectional illustration of an LED array with trenches;

FIG. 1C is a perspective illustration of another LED array with trenches;

FIG. 2A is a top view of the electronics board with LED array attached to the substrate at the LED device attach region in one embodiment;

FIG. 2B is a diagram of one embodiment of a two channel integrated LED lighting system with electronic components mounted on two surfaces of a circuit board;

FIG. 3 shows an example illumination system;

FIG. 4 shows an example system for controlling digital light sources in which one or more embodiments may be implemented; and

FIG. 5 is a flow diagram of an example control method for controlling digital light sources.

### DETAILED DESCRIPTION OF THE PREFERRED EMBODIMENTS

A lighting system comprising one or more digital light sources generally has many degrees of freedom in the form of the power supplied to each of the array elements, resulting in a corresponding (radiant or luminous) flux. For example, a lighting system consisting of 8 luminaires each comprising a 7×7 array of light emitting diode (LED) elements (e.g., 49 unique light distributions) has a total of 392 degrees of freedom. With so many parameters it is not straightforward to determine the flux values to achieve the targeted light distribution.

One approach is to create a model of the space that includes the luminaires and the angular intensity profile of each of the array elements. The illuminance at each point in the space can then be determined as the linear combination of the illuminance contributions of the array elements, and conversely, the optimal flux values of each array element for achieving the desired illuminance distribution can be determined by solving the corresponding linear system of equations. However, building a digital model of an arbitrary space can be time-consuming, especially since factors like daylight, object positions and reflectivity of surfaces have to be taken into account.

Examples of different light illumination systems and/or LED implementations will be described more fully hereinafter with reference to the accompanying drawings. These examples are not mutually exclusive, and features found in one example may be combined with features found in one or more other examples to achieve additional implementations. Accordingly, it will be understood that the examples shown in the accompanying drawings are provided for illustrative purposes only and they are not intended to limit the disclosure in any way. Like numbers refer to like elements throughout.

It will be understood that, although the terms first, second, third, etc. may be used herein to describe various elements, these elements should not be limited by these terms. These terms may be used to distinguish one element from another. For example, a first element may be termed a second element and a second element may be termed a first element without departing from the scope of the present invention. As used herein, the term “and/or” may include any and all combinations of one or more of the associated listed items.

It will be understood that when an element such as a layer, region, or substrate is referred to as being “on” or extending “onto” another element, it may be directly on or extend directly onto the other element or intervening elements may also be present. In contrast, when an element is referred to as being “directly on” or extending “directly onto” another element, there may be no intervening elements present. It will also be understood that when an element is referred to as being “connected” or “coupled” to another element, it may be directly connected or coupled to the other element and/or connected or coupled to the other element via one or more intervening elements. In contrast, when an element is referred to as being “directly connected” or “directly coupled” to another element, there are no intervening elements present between the element and the other element. It will be understood that these terms are intended to encompass different orientations of the element in addition to any orientation depicted in the figures.

Relative terms such as “below,” “above,” “upper,”, “lower,” “horizontal” or “vertical” may be used herein to describe a relationship of one element, layer, or region to another element, layer, or region as illustrated in the figures. It will be understood that these terms are intended to encompass different orientations of the device in addition to the orientation depicted in the figures.

Semiconductor light emitting devices (LEDs) or optical power emitting devices, such as devices that emit visible light, ultraviolet (UV) or infrared (IR) optical power, are among the most efficient light sources currently available. These devices (hereinafter “LEDs”), may include light emitting diodes, resonant cavity light emitting diodes, vertical cavity laser diodes, edge emitting lasers, or the like. Due to their compact size and lower power requirements, for example, LEDs may be attractive candidates for many different applications. For example, they may be used as light sources (e.g., flash lights and camera flashes) for hand-held battery-powered devices, such as cameras and cell phones. They may also be used, for example, for automotive lighting, heads up display (HUD) lighting, horticultural lighting, street lighting, torch for video, general illumination (e.g., home, shop, office and studio lighting, theater/stage lighting and architectural lighting), augmented reality (AR) lighting, virtual reality (VR) lighting, as back lights for displays, and IR spectroscopy. A single LED may provide light that is less bright than an incandescent light source, and, therefore arrays of LEDs (such as monolithic LED arrays, micro LED arrays, etc.) may be used for applications where more brightness is desired or required.

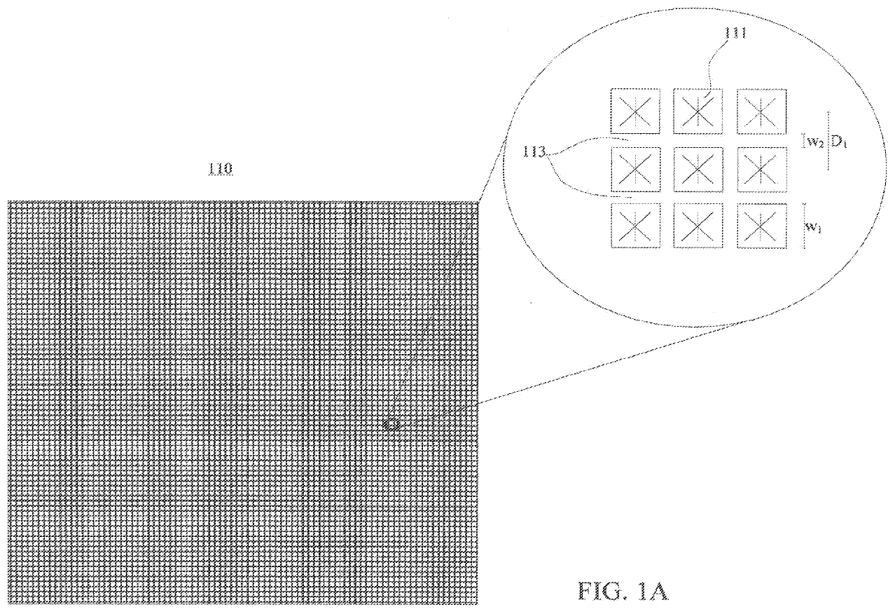

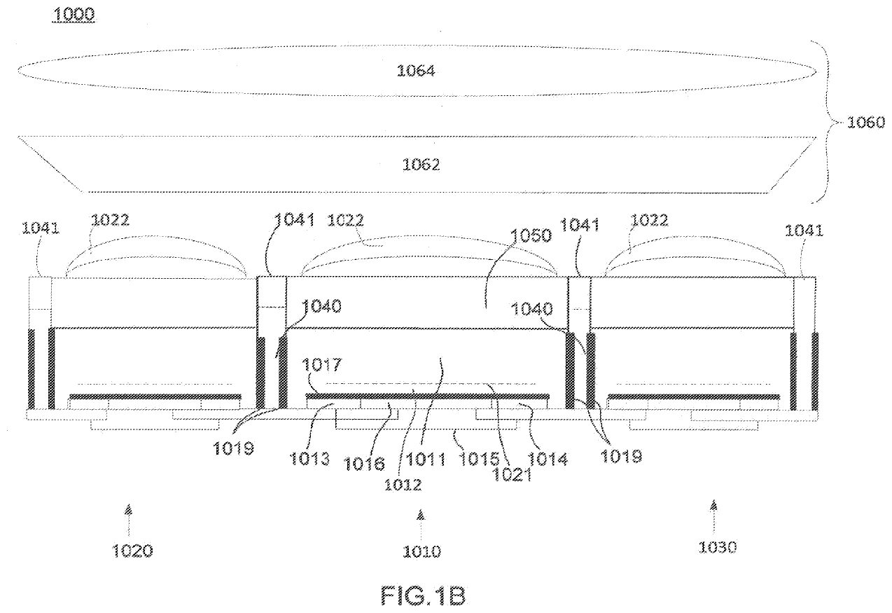

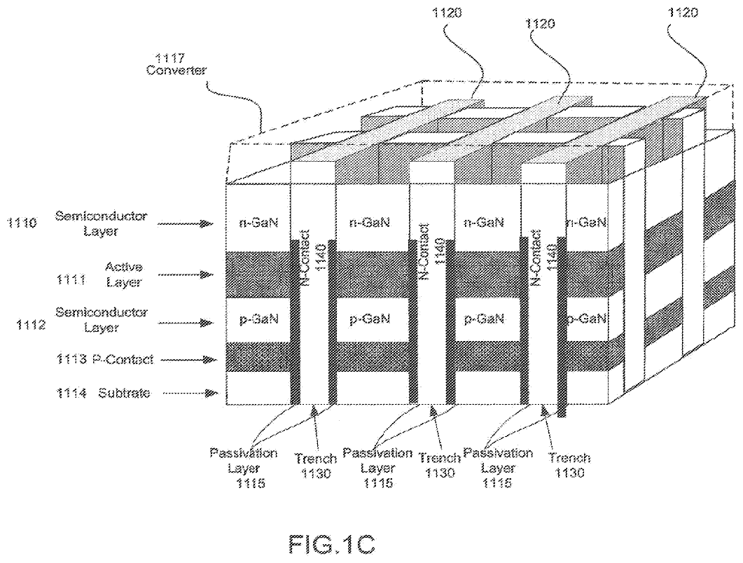

According to embodiments of the disclosed subject matter, -LED arrays (e.g., micro LED arrays) may include an array of pixels as shown in FIGS. 1A, 1B, and/or 1C. LED arrays may be used for any applications such as those requiring precision control of LED array segments. Pixels in an LED array may be individually addressable, may be addressable in groups/subsets, or may not be addressable. In FIG. 1A, a top view of a LED array 110 with pixels 111 is shown. An exploded view of a 3×3 portion of the LED array 110 is also shown in FIG. 1A. As shown in the 3×3 portion exploded view, LED array 110 may include pixels 111 with a width w₁ of approximately 100 μm or less (e.g., 40 μm). The lanes 113 between the pixels may be separated by a width, w₂, of approximately 20 μm or less (e.g., 5 μm). The lanes 113 may provide an air gap between pixels or may contain other material, as shown in FIGS. 1B and 1C and further disclosed herein. The distance di from the center of one pixel 111 to the center of an adjacent pixel 111 may be approximately 120 μm or less (e.g., 45 μm). It will be understood that the widths and distances provided herein are examples only, and that actual widths and/or dimensions may vary.

It will be understood that although rectangular pixels arranged in a symmetric matrix are shown in FIGS. 1A, B and C, pixels of any shape and arrangement may be applied to the embodiments disclosed herein. For example, LED array 110 of FIG. 1A may include, over 10,000 pixels in any applicable arrangement such as a 100×100 matrix, a 200×50 matrix, a symmetric matrix, a non-symmetric matrix, or the like. It will also be understood that multiple sets of pixels, matrixes, and/or boards may be arranged in any applicable format to implement the embodiments disclosed herein.

FIG. 1B shows a cross section view of an example LED array 1000. As shown, the pixels 1010, 1020, and 1030 correspond to three different pixels within an LED array such that a separation sections 1041 and/or n-type contacts 1040 separate the pixels from each other. According to an embodiment, the space between pixels may be occupied by an air gap. As shown, pixel 1010 includes an epitaxial layer 1011 which may be grown on any applicable substrate such as, for example, a sapphire substrate, which may be removed from the epitaxial layer 1011. A surface of the growth layer distal from contact 1015 may be substantially planar or may be patterned. A p-type region 1012 may be located in proximity to a p-contact 1017. An active region 1021 may be disposed adjacent to the n-type region and a p-type region 1012. Alternatively, the active region 1021 may be between a semiconductor layer or n-type region and p-type region 1012 and may receive a current such that the active region 1021 emits light beams. The p-contact 1017 may be in contact with SiO2 layers 1013 and 1014 as well as plated metal (e.g., plated copper) layer 1016. The n type contacts 1040 may include an applicable metal such as Cu. The metal layer 1016 may be in contact with a reflective layer 1015 which may serve as a contact.

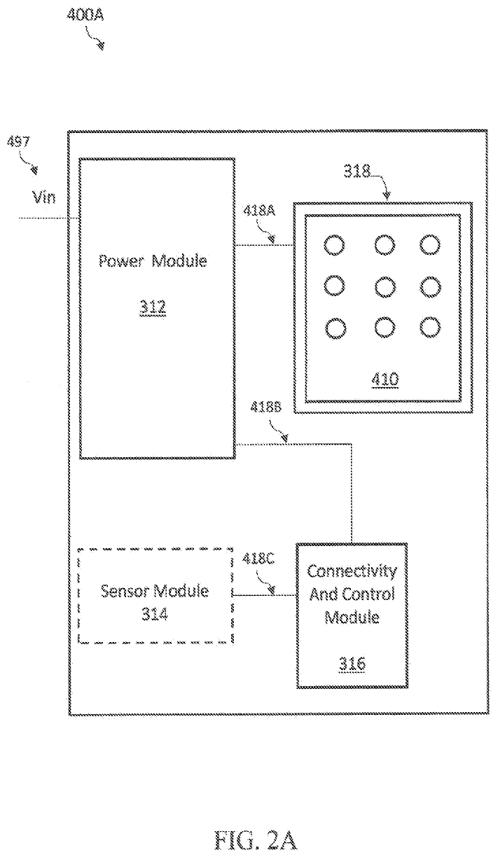

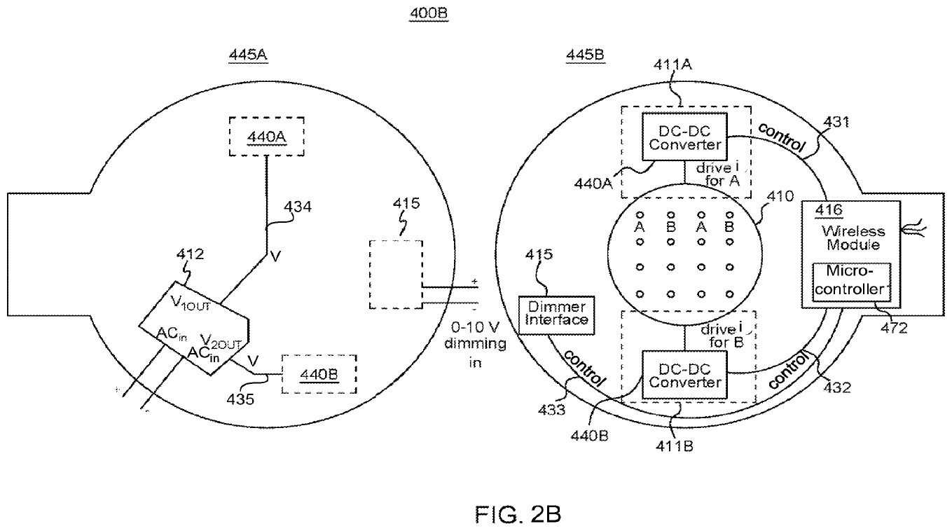

Notably, as shown in FIG. 1B, the n-type contact 1040 may be deposited into trenches 1130 created between pixels 1010, 1020, and 1030 and may extend beyond the epitaxial layer. Separation sections 1041 may separate all (as shown) or part of a converter material 1050. It will be understood that a LED array may be implemented without such separation sections 1041 or the separation sections 1041 may correspond to an air gap. The separation sections 1041 may be an extension of the n-type contacts 1040, such that, separation sections 1041 are formed from the same material as the n-type contacts 1040 (e.g., copper). Alternatively, the separation sections 1041 may be formed from a material different than the n-type contacts 1040. According to an embodiment, separation sections 1041 may include reflective material. The material in separation sections 1041 and/or the n-type contact 1040 may be deposited in any applicable manner such as, for example, but applying a mesh structure which includes or allows the deposition of the n-type contact 1040 and/or separation sections 1041. Converter material 1050 may have features/properties similar to wavelength converting layer 205 of FIG. 2A. As noted herein, one or more additional layers may coat the separation sections 1041. Such a layer may be a reflective layer, a scattering layer, an absorptive layer, or any other applicable layer. One or more passivation layers 1019 may fully or partially separate the n-contact 1040 from the epitaxial layer 1011.

The epitaxial layer 1011 may be formed from any applicable material to emit photons when excited including sapphire, SiC, GaN, Silicone and may more specifically be formed from a III-V semiconductors including, but not limited to, AlN, AlP, AlAs, AlSb, GaN, GaP, GaAs, GaSb, InN, InP, InAs, InSb, II-VI semiconductors including, but not limited to, ZnS, ZnSe, CdSe, CdTe, group IV semiconductors including, but not limited to Ge, Si, SiC, and mixtures or alloys thereof. These example semiconductors may have indices of refraction ranging from about 2.4 to about 4.1 at the typical emission wavelengths of LEDs in which they are present. For example, III-Nitride semiconductors, such as GaN, may have refractive indices of about 2.4 at 500 nm, and III-Phosphide semiconductors, such as InGaP, may have refractive indices of about 3.7 at 600 nm. Contacts coupled to the LED device 200 may be formed from a solder, such as AuSn, AuGa, AuSi or SAC solders.

The n-type region may be grown on a growth substrate and may include one or more layers of semiconductor material that include different compositions and dopant concentrations including, for example, preparation layers, such as buffer or nucleation layers, and/or layers designed to facilitate removal of the growth substrate. These layers may be n-type or not intentionally doped, or may even be p-type device layers. The layers may be designed for particular optical, material, or electrical properties desirable for the light emitting region to efficiently emit light. Similarly, the p-type region 1012 may include multiple layers of different composition, thickness, and dopant concentrations, including layers that are not intentionally doped, or n-type layers. An electrical current may be caused to flow through the p-n junction (e.g., via contacts) and the pixels may generate light of a first wavelength determined at least in part by the bandgap energy of the materials. A pixel may directly emit light (e.g., regular or direct emission LED) or may emit light into a wavelength converting layer 1050 (e.g., phosphor converted LED, “PCLED”, etc.) that acts to further modify wavelength of the emitted light to output a light of a second wavelength.

Although FIG. 1B shows an example LED array 1000 with pixels 1010, 1020, and 1030 in an example arrangement, it will be understood that pixels in an LED array may be provided in any one of a number of arrangements. For example, the pixels may be in a flip chip structure, a vertical injection thin film (VTF) structure, a multi-junction structure, a thin film flip chip (TFFC), lateral devices, etc. For example, a lateral LED pixel may be similar to a flip chip LED pixel but may not be flipped upside down for direct connection of the electrodes to a substrate or package. A TFFC may also be similar to a flip chip LED pixel but may have the growth substrate removed (leaving the thin film semiconductor layers un-supported). In contrast, the growth substrate or other substrate may be included as part of a flip chip LED.

The wavelength converting layer 1050 may be in the path of light emitted by active region 1021, such that the light emitted by active region 1021 may traverse through one or more intermediate layers (e.g., a photonic layer). According to embodiments, wavelength converting layer 1050 or may not be present in LED array 1000. The wavelength converting layer 1050 may include any luminescent material, such as, for example, phosphor particles in a transparent or translucent binder or matrix, or a ceramic phosphor element, which absorbs light of one wavelength and emits light of a different wavelength. The thickness of a wavelength converting layer 1050 may be determined based on the material used or application/wavelength for which the LED array 1000 or individual pixels 1010, 1020, and 1030 is/are arranged. For example, a wavelength converting layer 1050 may be approximately 20 μm, 50 μm or 200 μm. The wavelength converting layer 1050 may be provided on each individual pixel, as shown, or may be placed over an entire LED array 1000.

Primary optic 1022 may be on or over one or more pixels 1010, 1020, and/or 1030 and may allow light to pass from the active region 101 and/or the wavelength converting layer 1050 through the primary optic. Light via the primary optic may generally be emitted based on a Lambertian distribution pattern such that the luminous intensity of the light emitted via the primary optic 1022, when observed from an ideal diffuse radiator, is directly proportional to the cosine of the angle between the direction of the incident light and the surface normal. It will be understood that one or more properties of the primary optic 1022 may be modified to produce a light distribution pattern that is different than the Lambertian distribution pattern.

Secondary optics which include one or both of the lens 1065 and waveguide 1062 may be provided with pixels 1010, 1020, and/or 1030. It will be understood that although secondary optics are discussed in accordance with the example shown in FIG. 1B with multiple pixels, secondary optics may be provided for single pixels. Secondary optics may be used to spread the incoming light (diverging optics), or to gather incoming light into a collimated beam (collimating optics). The waveguide 1062 may be coated with a dielectric material, a metallization layer, or the like and may be provided to reflect or redirect incident light. In alternative embodiments, a lighting system may not include one or more of the following: the wavelength converting layer 1050, the primary optics 1022, the waveguide 1062 and the lens 1065.

Lens 1065 may be formed form any applicable transparent material such as, but not limited to SiC, aluminum oxide, diamond, or the like or a combination thereof. Lens 1065 may be used to modify a beam of light to be input into the lens 1065 such that an output beam from the lens 1065 will efficiently meet a desired photometric specification. Additionally, lens 1065 may serve one or more aesthetic purpose, such as by determining a lit and/or unlit appearance of the multiple LED devices 200B.

FIG. 1C shows a cross section of a three dimensional view of a LED array 1100. As shown, pixels in the LED array 1100 may be separated by trenches which are filled to form n-contacts 1140. The pixels may be grown on a substrate 1114 and may include a p-contact 1113, a p-GaN semiconductor layer 1112, an active region 1111, and an n-Gan semiconductor layer 1110. It will be understood that this structure is provided as an example only and one or more semiconductor or other applicable layers may be added, removed, or partially added or removed to implement the disclosure provided herein. A converter material 1117 may be deposited on the semiconductor layer 1110 (or other applicable layer).

Passivation layers 1115 may be formed within the trenches 1130 and n-contacts 1140 (e.g., copper contacts) may be deposited within the trenches 1130, as shown. The passivation layers 1115 may separate at least a portion of the n-contacts 1140 from one or more layers of the semiconductor. According to an implementation, the n-contacts 1140, or other applicable material, within the trenches may extend into the converter material 1117 such that the n-contacts 1140, or other applicable material, provide complete or partial optical isolation between the pixels.

FIG. 2A is a top view of an electronics board with an LED array 410 attached to a substrate at the LED device attach region 318 in one embodiment. The electronics board together with the LED array 410 represents an LED system 400A. Additionally, the power module 312 receives a voltage input at Vin 497 and control signals from the connectivity and control module 316 over traces 418B, and provides drive signals to the LED array 410 over traces 418A. The LED array 410 is turned on and off via the drive signals from the power module 312. In the embodiment shown in FIG. 2A, the connectivity and control module 316 receives sensor signals from the sensor module 314 over trace 418C.

FIG. 2B illustrates one embodiment of a two channel integrated LED lighting system with electronic components mounted on two surfaces of a circuit board 499. As shown in FIG. 2B, an LED lighting system 400B includes a first surface 445A having inputs to receive dimmer signals and AC power signals and an AC/DC converter circuit 412 mounted on it. The LED system 400B includes a second surface 445B with the dimmer interface circuit 415, DC-DC converter circuits 440A and 440B, a connectivity and control module 416 (a wireless module in this example) having a microcontroller 472, and an LED array 410 mounted on it. The LED array 410 is driven by two independent channels 411A and 411B. In alternative embodiments, a single channel may be used to provide the drive signals to an LED array, or any number of multiple channels may be used to provide the drive signals to an LED array.

The LED array 410 may include two groups of LED devices. In an example embodiment, the LED devices of group Aare electrically coupled to a first channel 411A and the LED devices of group B are electrically coupled to a second channel 411B. Each of the two DC-DC converters 440A and 440B may provide a respective drive current via single channels 411A and 411B, respectively, for driving a respective group of LEDs A and B in the LED array 410. The LEDs in one of the groups of LEDs may be configured to emit light having a different color point than the LEDs in the second group of LEDs. Control of the composite color point of light emitted by the LED array 410 may be tuned within a range by controlling the current and/or duty cycle applied by the individual DC/DC converter circuits 440A and 440B via a single channel 411A and 411B, respectively. Although the embodiment shown in FIG. 2B does not include a sensor module (as described in FIG. 2A), an alternative embodiment may include a sensor module.

The illustrated LED lighting system 400B is an integrated system in which the LED array 410 and the circuitry for operating the LED array 410 are provided on a single electronics board. Connections between modules on the same surface of the circuit board 499 may be electrically coupled for exchanging, for example, voltages, currents, and control signals between modules, by surface or sub-surface interconnections, such as traces 431, 432, 433, 434 and 435 or metallizations (not shown). Connections between modules on opposite surfaces of the circuit board 499 may be electrically coupled by through board interconnections, such as vias and metallizations (not shown).

According to embodiments, LED systems may be provided where an LED array is on a separate electronics board from the driver and control circuitry. According to other embodiments, a LED system may have the LED array together with some of the electronics on an electronics board separate from the driver circuit. For example, an LED system may include a power conversion module and an LED module located on a separate electronics board than the LED arrays.

According to embodiments, an LED system may include a multi-channel LED driver circuit. For example, an LED module may include embedded LED calibration and setting data and, for example, three groups of LEDs. One of ordinary skill in the art will recognize that any number of groups of LEDs may be used consistent with one or more applications. Individual LEDs within each group may be arranged in series or in parallel and the light having different color points may be provided. For example, warm white light may be provided by a first group of LEDs, a cool white light may be provided by a second group of LEDs, and a neutral white light may be provided by a third group.

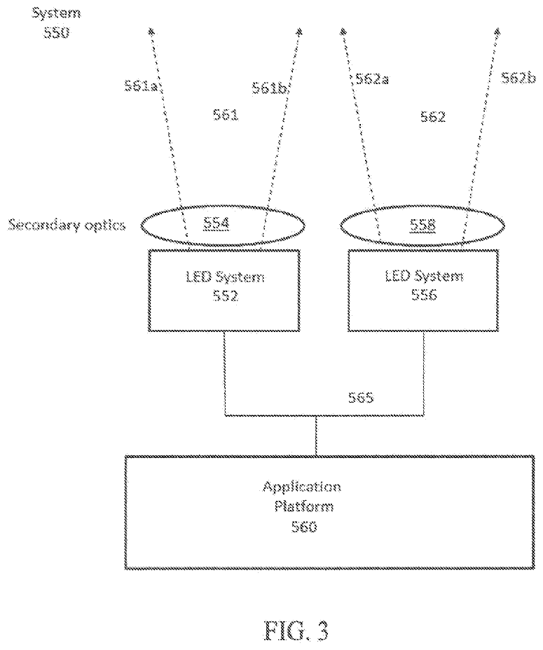

FIG. 3 shows an example system 550 which includes an application platform 560, LED systems 552 and 556, and optics 554 and 558. The LED System 552 produces light beams 561 shown between arrows 561a and 561b. The LED System 556 may produce light beams 562 between arrows 562a and 562b. In the embodiment shown in FIG. 3, the light emitted from LED System 552 passes through secondary optics 554, and the light emitted from the LED System 556 passes through secondary optics 556. In alternative embodiments, the light beams 561 and 562 do not pass through any secondary optics. The secondary optics may be or may include one or more light guides. The one or more light guides may be edge lit or may have an interior opening that defines an interior edge of the light guide. LED systems 552 and/or 556 may be inserted in the interior openings of the one or more light guides such that they inject light into the interior edge (interior opening light guide) or exterior edge (edge lit light guide) of the one or more light guides. LEDs in LED systems 552 and/or 556 may be arranged around the circumference of a base that is part of the light guide. According to an implementation, the base may be thermally conductive. According to an implementation, the base may be coupled to a heat-dissipating element that is disposed over the light guide. The heat-dissipating element may be arranged to receive heat generated by the LEDs via the thermally conductive base and dissipate the received heat. The one or more light guides may allow light emitted by LED systems 552 and 556 to be shaped in a desired manner such as, for example, with a gradient, a chamfered distribution, a narrow distribution, a wide distribution, an angular distribution, or the like.

In example embodiments, the system 550 may be a mobile phone of a camera flash system, indoor residential or commercial lighting, outdoor light such as street lighting, an automobile, a medical device, AR/VR devices, and robotic devices. The LED System 400A shown in FIG. 2A illustrate LED systems 552 and 556 in example embodiments.

The application platform 560 may provide power to the LED systems 552 and/or 556 via a power bus via line 565 or other applicable input, as discussed herein. Further, application platform 560 may provide input signals via line 565 for the operation of the LED system 552 and LED system 556, which input may be based on a user input/preference, a sensed reading, a preprogrammed or autonomously determined output, or the like. One or more sensors may be internal or external to the housing of the application platform 560. Alternatively or in addition, as shown in the LED system 400 of FIG. 2A, each LED System 552 and 556 may include its own sensor module, connectivity and control module, power module, and/or LED devices.

In embodiments, application platform 560 sensors and/or LED system 552 and/or 556 sensors may collect data such as visual data (e.g., LIDAR data, IR data, data collected via a camera, etc.), audio data, distance based data, movement data, environmental data, or the like or a combination thereof. The data may be related a physical item or entity such as an object, an individual, a vehicle, etc. For example, sensing equipment may collect object proximity data for an ADAS/AV based application, which may prioritize the detection and subsequent action based on the detection of a physical item or entity. The data may be collected based on emitting an optical signal by, for example, LED system 552 and/or 556, such as an IR signal and collecting data based on the emitted optical signal. The data may be collected by a different component than the component that emits the optical signal for the data collection. Continuing the example, sensing equipment may be located on an automobile and may emit a beam using a vertical-cavity surface-emitting laser (VCSEL). The one or more sensors may sense a response to the emitted beam or any other applicable input.

In example embodiment, application platform 560 may represent an automobile and LED system 552 and LED system 556 may represent automobile headlights. In various embodiments, the system 550 may represent an automobile with steerable light beams where LEDs may be selectively activated to provide steerable light. For example, an array of LEDs may be used to define or project a shape or pattern or illuminate only selected sections of a roadway. In an example embodiment, Infrared cameras or detector pixels within LED systems 552 and/or 556 may be sensors (e.g., similar to sensors module 314 of FIG. 2A and 307 of FIG. 2C) that identify portions of a scene (roadway, pedestrian crossing, etc.) that require illumination.

A method and workflow for controlling digital light sources based on a set of illuminance sample points throughout the illuminated space. In an embodiment, a handheld location-aware photometry device is used to record the illuminance contribution of each array element in the lighting system at each illuminance sample point. The map created by this process is subsequently used to determine the flux value of each element for a given target light distribution.

The workflow and calculation method are based on the premise that the illuminance Eat a surface is a linear combination of the illuminance from all light sources incident on that surface. Therefore, for a lighting system with n array elements, the illuminance Eₛ at a sample surface s can be written as:

$${E}_{s} = {a}_{s 1} {x}_{1} + {a}_{s 2} {x}_{2} + … + {a}_{s n} {x}_{n}$$

where aₛₜ is the illuminance at surface s due to array element tat nominal power, and xₜ is the relative flux of array element t. With m sample points, this can be written as a matrix equation:

$$[ \begin{matrix}{E}_{1} \\ ⋮ \\ {E}_{m}\end{matrix} ] = [ \begin{matrix}{a}_{11} & … & {a}_{1 n} \\ ⋮ & ⋱ & ⋮ \\ {a}_{m1} & … & {a}_{mn}\end{matrix} ] [ \begin{matrix}{x}_{1} \\ ⋮ \\ {x}_{n}\end{matrix} ]$$

or in matrix notation:

$$E = A \cdot x .$$

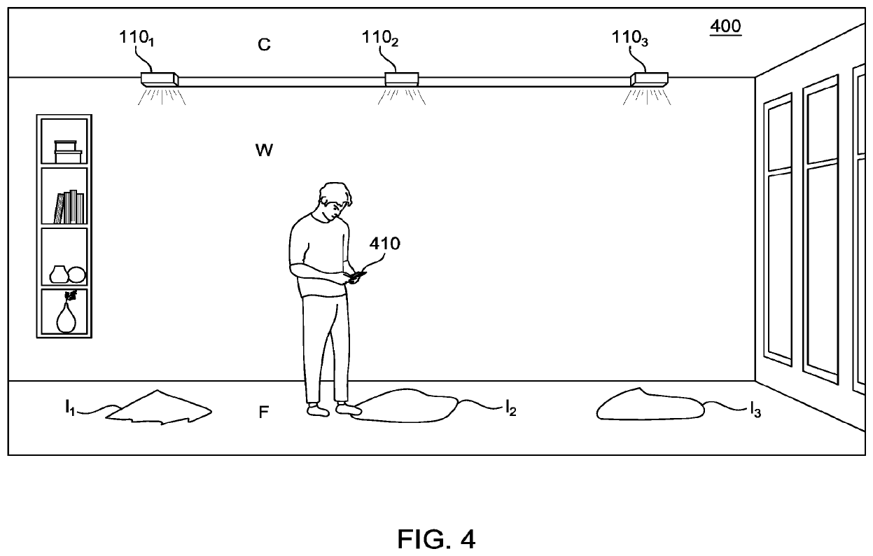

FIG. 4 shows an example system 400 for controlling digital light sources in which one or more embodiments may be implemented. As shown in system 400, there are multiple LED arrays 110 (designated 1101, 1102, and 1103). Although three LED arrays 110 are shown, it should be understood that more or less may be present in the system 400. For purposes of example, the LED arrays 110 are shown as being mounted to a ceiling C above a wall W, and emitting light toward a floor F.

The light emissions on the floor F are shown for purposes of example as 11, 12, and 13, being emitted from LED arrays 1101, 1102, and 1103, respectively. Person is shown holding a handheld location-aware photometry device 410 to measure illuminance at each location 11, 12, and 13 or any other location desired to take measurements.

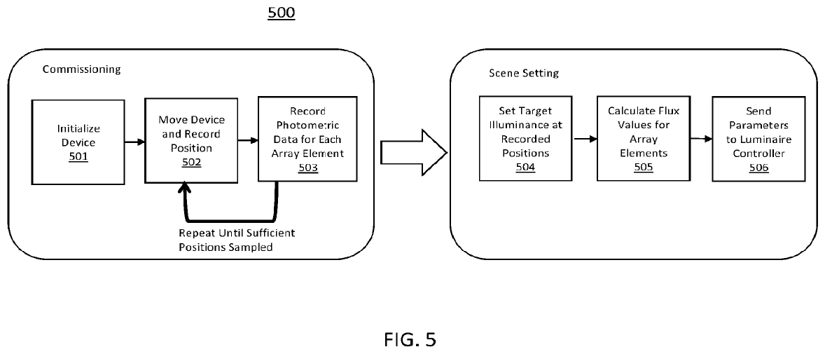

With this framework, the workflow can be divided into two parts as shown in FIG. 5, which is a flow diagram of an example control method 500 for controlling digital light sources. The control method 500 includes commissioning and scene-setting. The goal of the commissioning is to populate matrix A. This includes defining a set of m illuminance sample points in the space and determining the illuminance contribution of each of the n array elements at each of the sample points.

This matrix A is purely a property of the space and the lighting system and therefore this step is done only once after installation of the lighting system or whenever there are major structural changes to the space (like putting up a partition or moving large pieces of furniture). Scene-setting consists of determining the target illuminance vector E comprising the desired illuminance values at each of the previously defined sample points, and calculating the vector x of relative flux values for which the illuminance approximates the target vector E as closely as possible. This step is performed whenever a change in lighting distribution is desired.

Several methods may be used for the commissioning part of the workflow. One embodiment uses a handheld device (e.g., handheld device 410 of FIG. 4) that can determine its position in the space and has photometric measurement capabilities. The device may be a smartphone running an app that implements the workflow described. The device is be able to determine its position and orientation in the space that is illuminated by the lighting system (e.g. system 400). This may be accomplished by a variety of known methods including GPS, beacon triangulation, gyroscopes, accelerometers and LIDAR. The photometric measurement capabilities may be provided by the phone's built-in camera or light sensor, or by a peripheral photometer connected to the device. The method generally includes steps 501, 502 and 503 as shown in FIG. 5, which are described in additional detail below.

In step 501, the device (e.g., device 410) is initialized. The initialization step may include initializing the positioning method, establishing wireless communication with the luminaires (e.g., LED arrays 110) and/or initializing a commissioning mode on the luminaires.

In step 502, the device is moved and position is recorded. For example, the device is then moved to a measurement position in the space and the position and orientation of the device are stored. Alternatively, a sensor mesh, like a meshed net, could be suspended into the room to record lighting patterns as multiple locations. Another example technique for measurement may be to use a camera system and record the luminance from every surface. Utilizing intelligence and information on the room and objects is can aid the measurement device to convert the camera image to an illuminance mesh. The system may employ multiple camera positions or multiple cameras.

In step 503, the device records the photometric data of the light contribution from each of the array elements (e.g., LED arrays 110) at the current position and orientation. In order for this to work the device needs to be able to distinguish the light coming from each array element. This may be accomplished in several ways. In a first example, the device communicates directly with the luminaire control system and turns on the array elements sequentially while performing the photometric measurement. In a second example, the luminaire sends a trigger signal to the device and subsequently turns on the elements in a predetermined sequence. In a third example, the luminaire operates all elements simultaneously but with different modulations, allowing the device to distinguish them. The modulation may differ, for example, in frequency or duty cycle.

The photometric quantities recorded may include illuminance, color and spectrum, or approximations thereof (e.g. in the case of a phone camera which is not a full spectrometer). The device may also record ambient light at each position.

Steps 502 and 503 are repeated until a sufficient number of positions have been sampled. The number of sample points m is preferably of the same order as the number of array elements n, or higher, in order to make the system of equations sufficiently determined.

Alternatively, commissioning is performed without a device physically moving through the space. In one method, the luminaires have sensors that enable them to determine their relative position in the space as well as their distance to a grid of illuminance sample points (for example, on the floor). The illuminance from each array element at each sample point may then be calculated from the intensity profiles of the luminaire (which are independent of the space layout and can therefore be preprogrammed). In another method, the illuminance is measured with one or more devices at a fixed position. For example, a camera device with ranging capabilities may be used to estimate illuminance at multiple points from a single vantage point. Commissioning can also be done computational, for example, with manufacturer-supplied information of the light sources combined with knowledge on room dimensions, positions of light sources and objects.

The scene-setting part of the workflow includes steps 504, 505 and 506.

In step 504, the target illuminance is set at recorded positions. The desired lighting design is defined in terms of illuminance at each of the sample points (e.g., at a measured location). Color may also be included if the lighting system has color tuning capability. This step may involve manually setting the target illuminance at each sample point through a graphical user interface (GUI) showing a map of the sample points in the space. Alternatively, a predefined lighting design for the space can be mapped onto the available sample points. Yet another method is to use a location-aware device, which can be the same as the one used for commissioning. The user may then move the device to specific locations in the space and set the target illuminance at that location or define for example a beam with a certain diameter and beam profile centered at that location. If the device is also orientation-aware, a “point and click” type interface may be used where the device is aimed at the location for which the target illuminance is to be set.

In step 505, flux values for the array elements are calculated. The optimal flux values for each of the array elements for achieving the desired lighting design are calculated, based on the data collected in the commissioning part of the workflow. The calculation is described herein below.

In step 506, the parameters are sent to the controller. The calculated flux values are translated to their corresponding electrical power parameters (current and/or PWM duty cycle) and sent to the luminaire controller or lighting control system. The controller and a power module may reside in a light source fixture. Additionally, there may be a controller that is connected to multiple fixtures. Either controller may perform calculations.

Steps 504, 505 and 506 are repeated whenever a change in lighting distribution is desired or when the desired lighting pattern is not fully achieved, for example. It may also be repeated multiple times to create different scenes that in later operation can be activated manually by a user interface or automatically based on e.g. time of day or sensor input. The scene-setting part of the workflow may be implemented on the same device as the commissioning part, e.g. through an app on a smartphone. It may also be implemented on a different device that has access to the commissioning data and can communicate with the lighting system.

When the number of sample points m equals the number of array elements n, matrix A is square and calculation of the vector x may be done through a simple matrix inversion. However, this generally produces a vector x with elements outside the 0-1 range, meaning the solution cannot be physically represented with the lighting system. A more practical solution is therefore to use a least-squares fitting algorithm with the constraint that all parameters must be in the 0-1 range. Such algorithms are known as non-negative least-squares (NNLS) algorithms and implementations are readily available in many programming languages.

Generally, the matrix A does not need to be square but for an effective solution it is desirable that m and n are similar in magnitude (m<<n is an underdetermined problem which may lead to undesirable/unintended lighting distributions, while m>>n increases calculation time without improving the result). Additional constraints may be readily added to the NNLS algorithm. For example, an upper or lower bound may be placed on the illuminance at some of the sample points to ensure the found solution is within those bounds. Other constraints may be that energy consumption is minimized, or that the total power stays below the power rating of the lighting system. It is also possible to apply weighting factors in NNLS algorithms, for example if meeting the target lighting distribution is more critical in some areas than others.

For a color-tunable lighting system, the matrix equation may be set up in similar way but with a larger matrix capturing the additional degrees of freedom from color tuning. For example, for a system with 3 primaries (R, G and B) that are each segmented into n elements, the matrix equation would be:

$$[ \begin{matrix}{X}_{1} \\ ⋮ \\ {X}_{m} \\ {Y}_{1} \\ ⋮ \\ {Y}_{m} \\ {Z}_{1} \\ ⋮ \\ {Z}_{m}\end{matrix} ] = [ \begin{matrix}{a}_{R 1 X 1} & … & {a}_{R nX 1} & {a}_{G 1 X 1} & … & {a}_{GnX 1} & {a}_{B 1 X 1} & … & {a}_{BnX 1} \\ ⋮ & ⋱ & ⋮ & ⋮ & ⋱ & ⋮ & ⋮ & ⋱ & ⋮ \\ {a}_{R 1 Xm} & … & {a}_{R nXm} & {a}_{G 1 X m} & … & {a}_{GnX m} & {a}_{B 1 Xm} & … & {a}_{BnXm} \\ {a}_{R 1 Y 1} & … & {a}_{R nY 1} & {a}_{G 1 Y 1} & … & {a}_{GnY 1} & {a}_{B 1 Y 1} & … & {a}_{BnX 1} \\ ⋮ & ⋱ & ⋮ & ⋮ & ⋱ & ⋮ & ⋮ & ⋱ & ⋮ \\ {a}_{R 1 Ym} & … & {a}_{R nYm} & {a}_{G 1 Ym} & … & {a}_{GnYm} & {a}_{B 1 Ym} & … & {a}_{BnXm} \\ {a}_{R 1 Z 1} & … & {a}_{R nZ 1} & {a}_{G 1 Z 1} & … & {a}_{GnZ 1} & {a}_{B 1 Z 1} & … & {a}_{BnX 1} \\ ⋮ & ⋱ & ⋮ & ⋮ & ⋱ & ⋮ & ⋮ & ⋱ & ⋮ \\ {a}_{R 1 Zm} & … & {a}_{RnZm} & {a}_{G 1 Zm} & … & {a}_{GnZm} & {a}_{B 1 Zm} & … & {a}_{BnXm}\end{matrix} ] [ \begin{matrix}{R}_{1} \\ ⋮ \\ {R}_{n} \\ {G}_{1} \\ ⋮ \\ {G}_{n} \\ {B}_{1} \\ ⋮ \\ {B}_{n}\end{matrix} ] .$$

Here, the illuminance vector E comprises the target illuminance and target color expressed in any 3-dimensional color space, for example XYZ tristimulus values, and the solution vector x comprises the relative flux values of all n elements of the three primaries R, G and B.

Having described the embodiments in detail, those skilled in the art will appreciate that, given the present description, modifications may be made to the embodiments described herein without departing from the spirit of the inventive concept. Therefore, it is not intended that the scope of the invention be limited to the specific embodiments illustrated and described.

1. A method for controlling light sources of a lighting system, comprising:
initializing a measurement device for measuring information in the lighting system;
recording photometric data at a first location;
measuring photometric data at a second location;
setting a target illuminance in the system at the first and second locations;
calculating flux values for lighting elements of the lighting system; and
transmitting control parameters based upon the flux values for adjustment of the elements in the lighting system.

2. The method of claim 1, further comprising moving the measurement device to a plurality of subsequent locations and measuring photometric data at each of the subsequent locations.

3. The method of claim 2, further comprising for each of the subsequent locations:
setting target illuminance in the system;
calculating flux values for lighting elements of the lighting system; and
transmitting control parameters based upon the flux for adjustment of the elements in the lighting system.

4. The method of claim 1, further comprising the measurement device establishing wireless communication with the light sources of the lighting system.

5. The method of claim 1, further comprising measuring a light contribution from each of an element of a light emitting diode (LED) array at a current position and orientation of the measurement device.

6. The method of claim 1, further comprising the photometric data including one or more of the following data: illuminance, color and spectrum.

7. The method of claim 1, further comprising setting the target illuminance at each of the first and second locations through a graphical user interface (GUI) showing a map of the first and second locations in a total space occupied by the first and second locations.

8. The method of claim 1, further comprising translating flux values to their corresponding electrical power parameters.

9. The method of claim 1, further comprising adjusting the light sources based upon the received control parameters.

10. The method of claim 1, further comprising upon a change in lighting distribution being desired, performing until a desired distribution is achieved:
setting the target illuminance in the system at the first and second locations;
calculating flux values for lighting elements of the lighting system; and
transmitting control parameters based upon the flux values for adjustment of the elements in the lighting system.

11. A lighting control system, comprising:
one or more lighting arrays including one or more lighting elements;
a controller, operatively coupled with and in communication with the one or more lighting arrays; and
a measurement device in communication with the controller,
the measurement device records photometric data at a first location and measures photometric data at the second location, and transmits the photometric data measured at the first and second locations to the controller,
the controller sets a target illuminance in the system at the first and second locations, calculates flux values for lighting elements of the lighting system and transmits control parameters based upon the flux values for adjustment of the one or more lighting elements in the one or more lighting arrays.

12. The lighting control system of claim 11, further comprising the measurement device being moved to a plurality of subsequent locations and measuring photometric data at each of the subsequent locations.

13. The lighting control system of claim 12, further comprising for each of the subsequent locations, the controller:
setting target illuminance in the system;
calculating flux values for lighting elements of the lighting system; and
transmitting control parameters based upon the flux for adjustment of the one or more lighting elements in the one or more lighting arrays.

14. The lighting control system of claim 11, further comprising the measurement device establishing wireless communication with the controller.

15. The lighting control system of claim 11, further comprising the measurement device measuring a light contribution from each of an element of a light emitting diode (LED) array at a current position and orientation of the measurement device.

16. The lighting control system of claim 11, further comprising the photometric data including one or more of the following data: illuminance, color and spectrum.

17. The lighting control system of claim 11, further comprising the controller setting the target illuminance by setting the target illuminance at each of the first and second locations through a graphical user interface (GUI) showing a map of the first and second locations in a total space occupied by the first and second locations.

18. The lighting control system of claim 11, further comprising the controller translating flux values to their corresponding electrical power parameters.

19. The lighting control system of claim 11, further comprising the lighting arrays adjusting the light sources based upon the received control parameters.

20. The lighting control system of claim 11, further comprising upon a change in lighting distribution being desired, the controller performing until a desired distribution is achieved:
setting the target illuminance in the system at the first and second locations;
calculating flux values for lighting elements of the lighting system; and
transmitting control parameters based upon the flux values for adjustment of the elements in the lighting system.
